(19) United States
(12) Patent Application Publication
(10) Pub. No.: US 2017/0041131 A1
(43) Pub. Date: Feb. 9, 2017

(54) WIRELESS COMMUNICATION SYSTEM AND TIME SYNCHRONIZATION METHOD OF THE SAME

(71) Applicants: Wei-Sheng Yang, TAICHUNG CITY (TW); Shi-Xian Yang, TAINAN CITY (TW)

(72) Inventors: Wei-Sheng Yang, TAICHUNG CITY (TW); Shi-Xian Yang, TAINAN CITY (TW)

(73) Assignee: SkyTraq Technology, Inc., Hsinchu City (TW)

(21) Appl. No.: 15/297,439

(22) Filed: Oct. 19, 2016

Related U.S. Application Data
(63) Continuation-in-part of application No. 13/545,664, filed on Jul. 10, 2012, now abandoned.

(51) Int. Cl. H04L 7/033; H04L 7/00

(52) U.S. Cl. CPC H04L 7/033; H04L 7/0016

(57) ABSTRACT

A wireless communication system having a time synchronization mechanism is provided. The wireless communication system comprises a first receiver and a second receiver. The first receiver tracks a code phase data of a satellite to generate a synchronization data related to a sync phase position and a first receiver phase position corresponding to one of first receiver time pulses. The second receiver comprises a receiving unit, a tracking unit and a computing unit. The receiving unit receives the synchronization data from the first receiver through a network. The tracking unit tracks the code phase data of the satellite to obtain a second receiver phase position corresponding to one of second receiver time pulses. The computing unit performs a time synchronization process with the first receiver and the satellite according to the code phase data, the synchronization data and the second receiver phase position.

### CROSS-REFERENCE TO RELATED APPLICATIONS

This application is a continuation-in-part (CIP) application of Ser. No. 13/545,664, filed on Jul. 10, 2012 now pending, which is incorporated herein by reference.

### FIELD OF THE INVENTION

The present invention relates to a communication technology, and more particularly to a wireless communication system and a time synchronization method of the same.

### BACKGROUND OF THE INVENTION

Satellite positioning system (SPS) receivers have been used to provide location, time, timing, and/or frequency reference information. In satellite systems, the clocks in the receivers will have phase mismatch and frequency mismatch with the clocks in the satellites. In order to make the receivers synchronize with the satellites, it is typical to compute the clock bias between the receivers and the satellite. In conventional technology, at least four satellites are used to compute the 3-D (three-dimensional) location and the clock bias of the receivers such that the receivers can synchronize with the satellites. The synchronization process is time-consuming.

Thus, there is a need for an improved wireless communication system and a time synchronization method of the same to provide an accurate and fast time synchronization mechanism.

### SUMMARY OF THE INVENTION

Embodiments of the subject invention relate to a method and/or system for performing a time synchronization process on devices in a wireless communication system.

In one aspect, a wireless communication system having a time synchronization mechanism is provided. The wireless communication system may include a first receiver and a second receiver. The first receiver tracks a code phase data of a satellite to generate a synchronization data related to a sync phase position and a first receiver phase position corresponding to one of first receiver time pulses. The second receiver comprises a receiving unit, a tracking unit and a computing unit. The receiving unit receives the synchronization data from the first receiver through a network. The tracking unit tracks the code phase data of the satellite to obtain a second receiver phase position corresponding to one of second receiver time pulses. The computing unit performs a time synchronization process with the first receiver and the satellite according to the code phase data, the synchronization data and the second receiver phase position.

In another embodiment, the first receiver can obtain its position relative to the satellite by a procedure of three-dimensional (3-D) fix first. In other words, the first receiver can perform the 3-D fix process by using at least four satellites first to obtain its position relative to the satellite If the first receiver can simultaneously receive signals from four satellites, four equations can be obtained as following, and the position of the first receiver can be obtained by some mathematical methods such as least square.

The first receiver can obtain the position of the satellite after the 3-D fix by tracking the code phase data of the satellite. A first phase offset (depicted as Offset1) is presented between the position of the satellite and the first receiver's position since the first receiver and the satellite are not synchronized. Hence, by tracking the code phase data of the satellite, the first phase offset (Offset1) can be computed according to the position of the satellite and the first receiver position corresponding to the satellite time pulse and the first receiver time pulse respectively.

Accordingly, the computing unit of the second receiver is configured to perform a time synchronization process with the first receiver and the satellite according to the code phase data, the synchronization data and the position of the second receiver. In an embodiment, after receiving the synchronization data from the first receiver, the computing unit of the second receiver can compute the second phase offset (depicted as Offset2) between the position of the satellite and the second receiver's position according to the synchronization data. After Offset2 is computed, the first receiver and the second receiver generate the synchronized time pulse corresponding to the satellite time pulse according to Offset1 and Offset2.

Various embodiments are illustrated in the figures and description provided herein. It should be understood, however, that the subject invention is not limited to the specific embodiments illustrated in the figures and specifically described herein.

### BRIEF DESCRIPTION OF THE DRAWINGS

FIG. 1 is a diagram depicting a wireless communication system in an embodiment of the present invention.

FIG. 2 is a diagram depicting three axes that represent the time line and the code phase line of the wireless communication system respectively in an embodiment of the present invention.

FIG. 3 is a block diagram of the second receiver in an embodiment of the present invention.

FIG. 4 is a diagram depicting the code phase of the wireless communication system 1 in an embodiment of the present invention.

FIG. 5 is a flow diagram of a time synchronization method in an embodiment of the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As used in the description herein and throughout the claims that follow, the meaning of “a”, an, and the includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of in includes in and on unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

GNSS (Global Navigation Satellite System) strongly relies on measuring the time of arrival of radio signal propagation. Thus, each GNSS System has its own time reference from which all elements of the space, control and user segments are time-synchronized, as well as most of the GNSS-based applications. GNSS Time is a continuous time scale (no leap seconds) defined by the GPS control segment on the basis of a set of atomic clocks at the Monitor Stations and onboard the satellites.

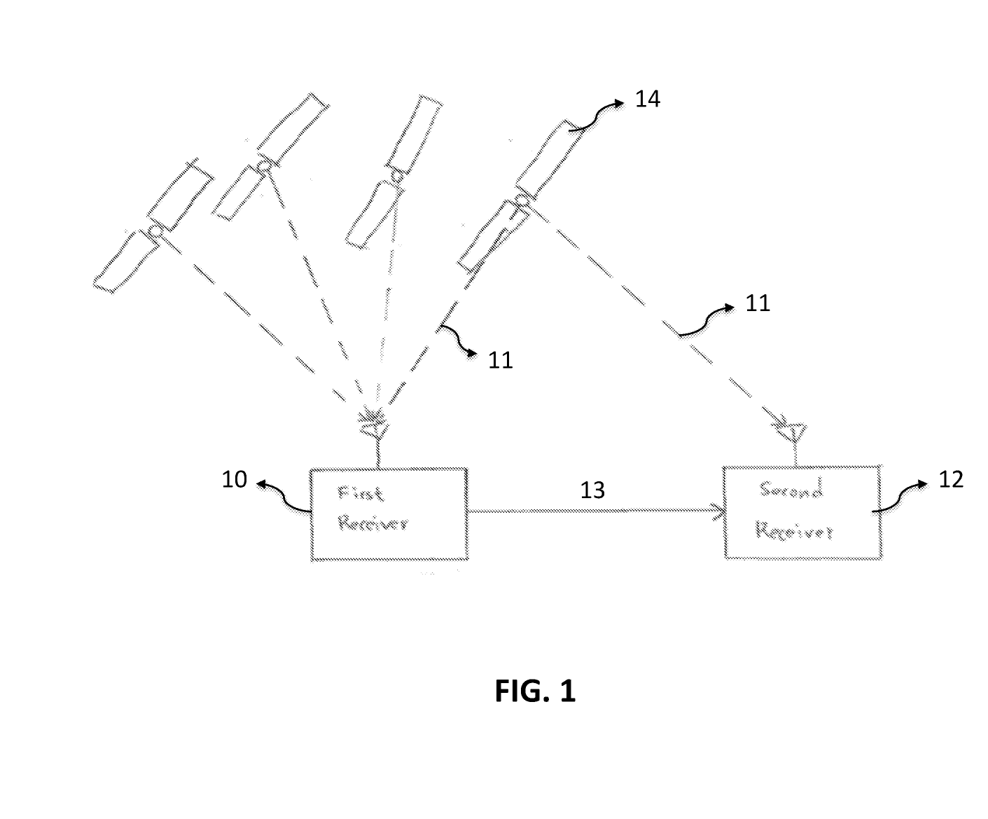

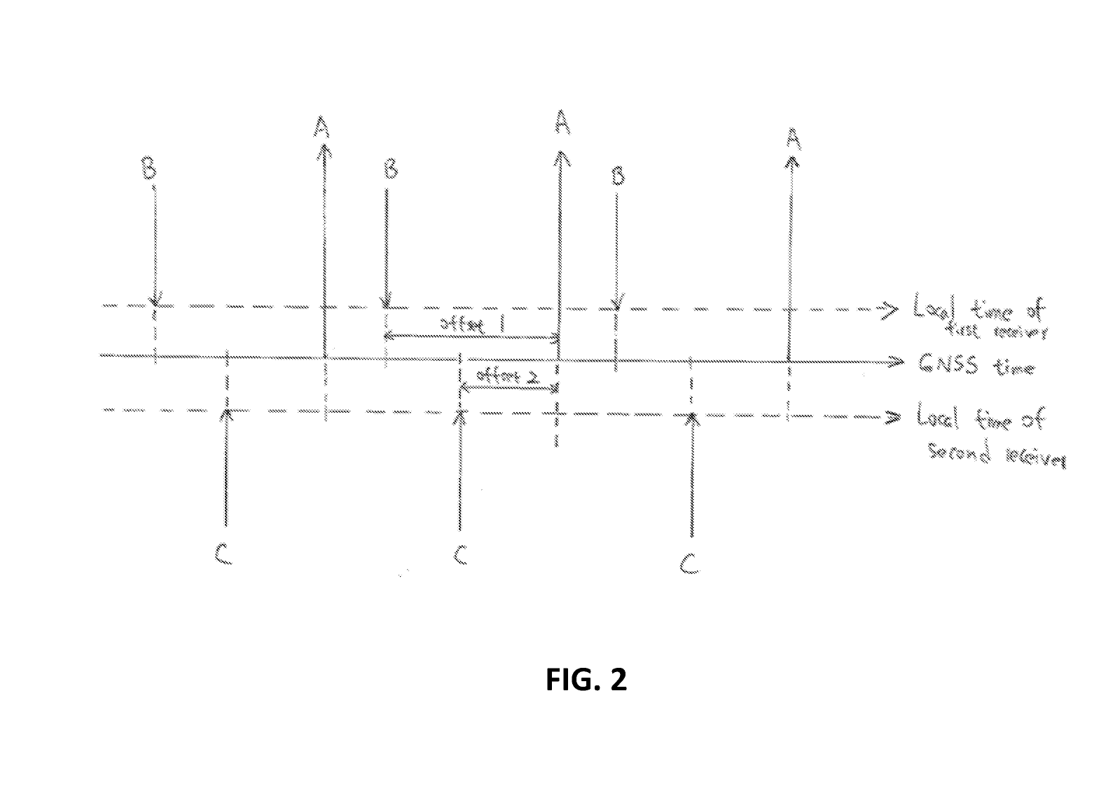

FIG. 1 is a diagram depicting a wireless communication system 1 in an embodiment of the present invention. The wireless communication system 1 comprises a first receiver 10 and a second receiver 12. FIG. 2 is a diagram depicting three axes that represent the time line and the code phase line of the wireless communication system 1, respectively, in an embodiment of the present invention. It is noted that each receiver has its own local clock, and the time on the clock is usually not synchronized with the GNSS time.

In one embodiment, the first receiver 10 is a server and the second receiver 12 is a client. In another embodiment, both the first receiver 10 and the second receiver 12 can be implemented in a portable electronic device. Each of the first receiver 10 and the second receiver 12 is configured to track a code phase signal 11 at a predetermined time pulse of a satellite 14.

Generally, the code phase signal 11 is a C/A (coarse/acquisition) code data. C/A code is a 1023 “chip” long code, being transmitted with a frequency of 1.023 MHz. A “chip” is the same as a “bit”, and is described by the numbers one or “zero”. The C/A code is a pseudo random code (PRN), which looks like a random code but is clearly defined for each satellite. It is repeated every 1023 bits or every millisecond. Therefore each second 1023000 chips are generated.

FIG. 2 illustrates a schematic diagram that represents the GNSS time (solid line), the local time of the first receiver 10 (top dash line), and the local time of the second receiver 12 (bottom dash line), wherein arrow A represents a time pulse occurring in a predetermined second in the GNSS timeline, arrow B represents a time pulse occurring in a predetermined second in the first receiver 10, and arrow C represents a time pulse occurring in a predetermined second in the second receiver 12.

As stated above, the local time in each receiver does not usually synchronize with the GNSS time, which can also be seen in FIG. 2 because arrows A, B and C do not overlap with each other. As shown in FIG. 2, a first offset (“Offset1) is generated between arrows A and B to indicate the time difference between the GNSS time (of the satellite 14) and the local time of the first receiver 10, while another offset (”Offset2) is generated between arrows A and C to indicate the time difference between the GNSS time (of the satellite 14) and the local time of the second receiver 12. It is noted that the main purpose of the present invention is to synchronize the local time of each receiver with the GNSS time by obtaining the time differences Offset1 and Offset2.

As stated above, the satellite 14 can generate a predetermined code phase signal 11 at a predetermined time pulse, and each receiver (10, 12) is configured to track the code phase signal 11 thereof. Thus, if the receiver can successfully track the code phase signal 11, it can also obtain the GNSS time on which the code phase signal 11 is generated. More specifically, the first receiver 10 may include a tracking unit 30 configured to generate “code replica” at the first receiver 10 locally. When matching and comparing the code replica with the received code phase signals 11 from the satellite 14, a “code phase” of the received code phase signals from the satellite 14 can be obtained, and further the GNSS time corresponding to that code phase can be obtained. For example, the satellite 14 may generate a code phase data with a pattern “ . . . 010001110001 . . . ” at a specific time pulse, which can be tracked by the receiver. And when the receiver receives such code phase data pattern “ . . . 010001110001 . . . ” at a different time pulse, the time difference (“offset”) between the satellite and the receiver can be generated, and the offset can be included in the synchronization data, which will be discussed below.

In one embodiment, when the first receiver 10 tracks one satellite 14, the code phase obtained at local time epoch can be written as:

code_phase_1=local_time_epoch-range1/C−Offset1 (i)

Wherein code_phase_1 is the code phase signals 11 tracked by the first receiver 10 as discussed above, local time epoch is the arrow B in FIG. 2, range 1 is the distance between the satellite 14 and the first receiver 10, C is the light speed, and Offset1 is the time difference between the first receiver 10 and the satellite 14 (GNSS time).

In another embodiment, (i) can be rewritten to: (local_time_epoch-code_phase_1)*C=range1+Offset1*C, wherein range1 is still the distance between the first receiver 10 and the satellite 14, and the coordinate of the satellite 14's position can be obtained through the formula related to the satellite orbits if the time that the code phase 1 appears is provided. At the present stage, only the coordinate of the first receiver 10 is unknown, which can be computed by some mathematical methods such as least square, and Offset1 can then be obtained.

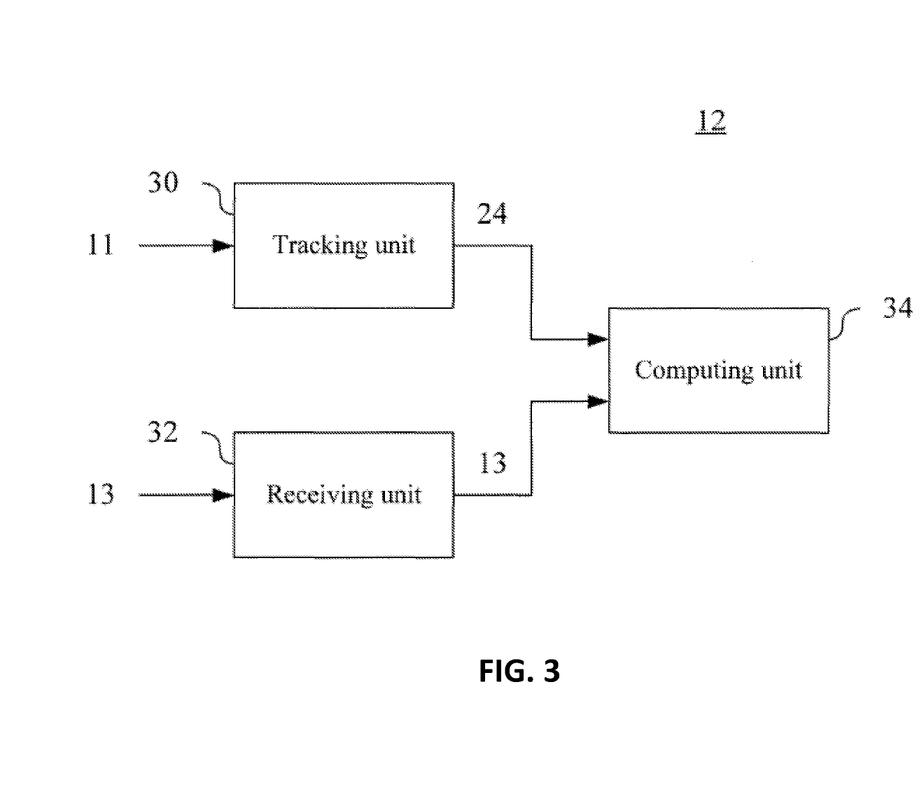

As shown in FIG. 3, the second receiver 12 may include a tracking unit 30′, a receiving unit 32 and a computing unit 34. Similar to the first receiver 10, the tracking unit 30′ of the second receiver 12 is configured to track the code phase signal 11 from the same satellite 14, and the code phase obtained at local time epoch at the second receiver 12 can be written as:

code_phase_2=local_time_epoch-range2/C−Offset2 (ii)

Wherein code_phase_2 is the code phase tracked by the second receiver 12, local_time_epoch is the arrow C in FIG. 2, range 2 is the distance between the satellite 14 and the second receiver 12, C is the light speed, and Offset2 is the time difference between the second receiver 12 and the satellite 14 (GNSS time) as stated above.

The first receiver 10 can then transmit synchronization data 13 to the receiving unit 32 of the second receiver 12 through a network, which may include Offset1, its local time epoch, and the code phase tracked by the first receiver 10, so code_phase_2 can be obtained by the second receiver 12 through the local time epoch identical in the first receiver 10. In one embodiment, the network can be a wired network, and in another embodiment, the network can be a wireless network.

After receiving the synchronization data 13 from the first receiver 10, the computing unit 34 of the second receiver 12 can compute Offser2 by subtracting equation (i) and equation (ii) as the following:

code_phase_1-code_phase_2=(range2−range1)/C+Offset2−Offset1,

or

Δcode_phase=range error/C+Offset2−Offset1 (iii)

If the distance between the first receiver 10 and second receiver 12 is not too far away, for example within a few kilometers, the result of the range error divided by the light speed would be very minimum, which can be ignored, so (iii) becomes:

Offset2=Offset1+(code_phase_1-code_phase_2) (iv)

For the second receiver 12, code_phase_2 can be obtained by its own tracking unit, and as stated above, the first receiver 10 can transmit the synchronization data 13 including Offset1 and code_phase_1 to the second receiver, so Offset2 can be easily computed.

After Offset2 is computed, the first receiver 10 and the second receiver 12 generate a synchronized time pulse according to the first phase offset (Offset1) and the second phase offset (Offset2).

Consequently, the second receiver 12 of the wireless communication system 1 of the present invention can quickly perform synchronization with the aid of only one satellite 14 by receiving the synchronization data 13 transmitted from the first receiver 10 through the network. Further, the second receiver 12 can quickly perform synchronization without the aid of ephemeris data and 3-D positioning. In an embodiment, the synchronization process of the present disclosure can accomplish microsecond accuracy.

It is noted that, in an embodiment, the first receiver 10 and the second receiver 12 can track different satellites to perform the synchronization process. For example, the first receiver 10 can track the code phase data of a first satellite (not shown) to generate a synchronization data while the second receiver 12 can track the code phase data of a second satellite (not shown) to obtain the code phase of the second receiver. The second receiver 12 can further receive the synchronization data from the first receiver 10 through the network and perform the synchronization process according to the synchronization data and the code phase of the second receiver. It is also noted that the accuracy in this embodiment may not be as high as previous embodiments because the receivers (10, 12) track different satellites.

In another embodiment, the first receiver 10 can obtain its position relative to the satellite 14 by a procedure of three-dimensional (3-D) fix first. In other words, the first receiver 10 can perform the 3-D fix process by using at least four satellites first to obtain its position relative to the satellite 14 as shown in FIG. 1. For example, if the first receiver 10 can simultaneously receive signals from four satellites, four equations can be obtained as following, and the position of the first receiver 10 can be obtained by some mathematical methods such as least square as discussed above.

(local_time_epoch-code_phase_1ₛᵥ₁)*C=range1ₛᵥ₁(x,y,z)+Offset1*C

(local_time_epoch-code_phase_1ₛᵥ₂)*C=range1ₛᵥ₂(x,y,z)+Offset1*C

(local_time_epoch-code_phase_1ₛᵥ₃)*C=range1ₛᵥ₃(x,y,z)+Offset1*C

(local_time_epoch-code_phase_1ₛᵥ₄)*C=range1ₛᵥ₄(x,y,z)+Offset1*C

Position A (arrow A) in FIG. 2 in the present embodiment can be the position of one satellite that corresponds to one of the satellite time pulses. The first receiver 10 can obtain position A of the satellite after the 3-D fix by tracking the code phase data 11 of the satellite 14 as shown in FIG. 2. A first phase offset (depicted as Offset1 in FIG. 2) is presented between position A of the satellite and the first receiver's position B (arrow B) since the first receiver 10 and the satellite 14 are not synchronized. Hence, by tracking the code phase data 11 of the satellite 14, the first phase offset (Offset1) can be computed according to the position A of the satellite and the first receiver position B corresponding to the satellite time pulse and the first receiver time pulse respectively.

Accordingly, the computing unit 34 of the second receiver 12 depicted in FIG. 3 performs a time synchronization process with the first receiver 10 and the satellite 14 according to the code phase data 11, the synchronization data 13 and the position of the second receiver 12. In an embodiment, after receiving the synchronization data 13 from the first receiver, the computing unit 34 of the second receiver 12 can compute the second phase offset (depicted as Offset2 in FIG. 2) between the position of the satellite and the second receiver's position C according to the synchronization data 13 as discussed above. After Offset2 is computed, the first receiver 10 and the second receiver 12 generate the synchronized time pulse corresponding to the satellite time pulse according to Offset1 and Offset2.

Consequently, the second receiver 12 of the wireless communication system 1, in accordance with specific embodiments of the present invention, can quickly perform synchronization with the aid of only one satellite by receiving the synchronization data 13 transmitted from the first receiver 10 through the network. Further, the second receiver 12 can quickly perform synchronization without the aid of ephemeris data and 3-D positioning. In an embodiment, the synchronization process, in accordance with specific embodiments of the present invention, can accomplish microsecond accuracy.

In an embodiment, each of the clocks in the first receiver 10 and the second receiver 12 has a clock drift. The clock drift is a hardware problem caused by variation in the crystal frequency due to noise, temperature, aging, voltage change etc. Similar to the calculation of the first receiver phase position 22, the first receiver 10 can compute its first receiver clock drift by tracking the code phase data 11 of the satellite 14 after the 3-D fix of the first receiver 10 as well. However, the second receiver 12 cannot compute its second receiver clock drift since the position of the second receiver 12 is unknown.

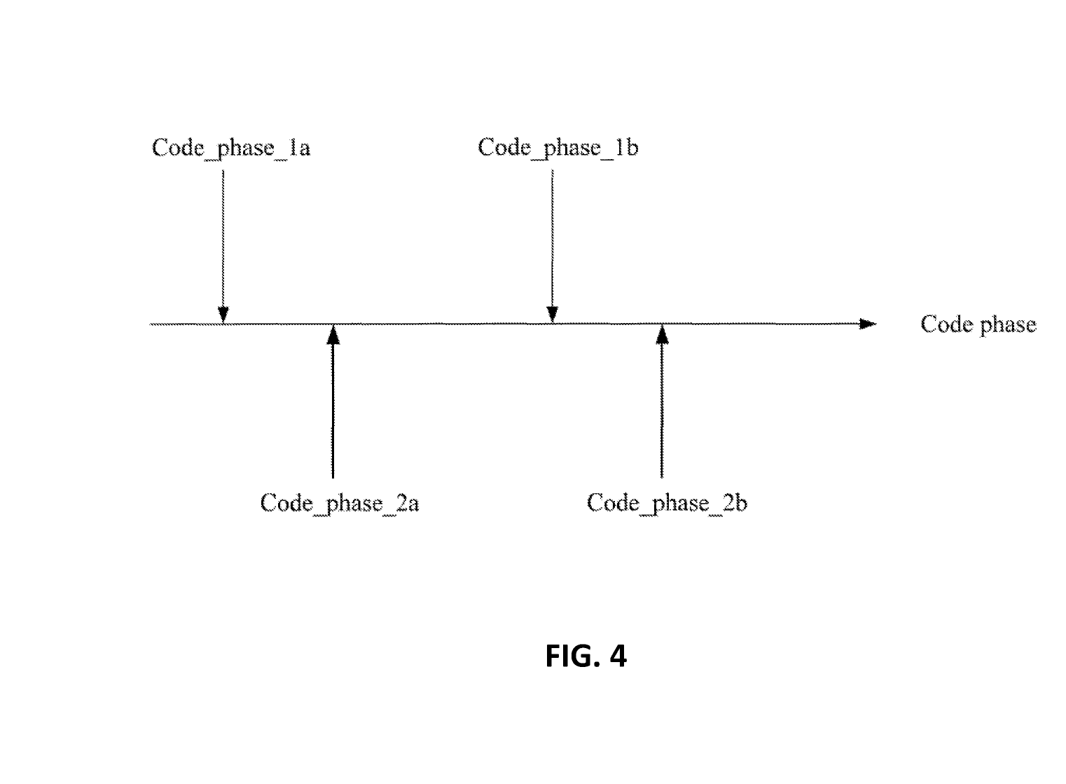

FIG. 4 is a diagram depicting the code phase of the wireless communication system 1 in an embodiment of the present invention. In an embodiment, the synchronization data 13 generated by the first receiver 10 can further comprise the first receiver clock drift and a first receiver phase position difference between neighboring two of the first receiver time pulses, i.e., the Code_phase_1a and the Code_phase_1b depicted in FIG. 4. The tracking unit 30 of the second receiver 12 can obtain a second receiver phase position difference between neighboring two of the second receiver time pulses, i.e., the Code phase_2a and the Code phase_2b depicted in FIG. 4, according to the tracking of the code phase data 11 such that the computing unit 34 of the second receiver 12 computes a second receiver clock drift according to the first receiver phase position difference and the second receiver phase position difference. When the distance from the first receiver 10 to the satellite 14 and the distance from the second receiver 12 to the satellite are substantially the same, such a distance D can be described by the following equation:

D=(Code_phase_1b-Code_phase_1a)×(C+cdrift1)=(Code_phase_2b-Code_phase_2a)×(C+cdrift2)

Wherein C is the speed of the light, cdrift1 is the first receiver clock drift and cdrift2 is the second receiver clock drift. In an embodiment, the speed of light is approximately 3×108 m/s. It is noted that the clock drift described herein is measured by the amount of speed affected on the signal transmitted by the satellite 14. Hence, the unit of cdrift1 and cdrift2 is m/s (meter per second).

From the above equation, the second receiver 12 can compute its second receiver clock drift quickly and take the clock drift into account to perform the synchronization with higher accuracy. In an embodiment, when the difference between the distance from the first receiver to the satellite 14 and the distance from the second receiver 12 to the satellite is larger than a predetermine value, the receiving unit 32 of the second receiver 12 can receive rough position information relative to the first receiver 10 to compensate a distance offset of the time synchronization process. In an embodiment, the receiving unit 32 of the second receiver 12 receives the rough position information from the network. For example, the receiving unit 32 of the second receiver 12 can receive the rough position information by using the signals from the base stations of the network, by using Wi-Fi positioning system or by acquiring the position (e.g., the city) corresponding to the IP (Internet Protocol) address of the second receiver 12.

Consequently, the second receiver 12 can use the rough position information to compensate the distance offset of the time synchronization process. For example, when the distance between the first receiver 10 and the second receiver 12 is within 100 meters, the time error generated due to the distance is not larger than 2 microseconds and the clock offset error is not larger than 5 Hz. When the distance between the first receiver 10 and the second receiver 12 is about 30 km, the time error generated due to the distance is about 20-70 microseconds and the clock offset error is about 5-20 Hz. When the distance between the first receiver 10 and the second receiver 12 is over 300 km, the time error generated due to the distance would become 80-400 microseconds and the clock offset error is about 40-180 Hz. Hence, when the distance between the first receiver 10 and the second receiver 12 becomes longer, the error of time and the clock offset is more critical and the compensation is more important.

Due to the transmission of the synchronization data 13 through the network, the network delay becomes a critical issue. In an embodiment, the tracking unit 30 of the second receiver 12 further obtains a frame sync data (not shown) of the satellite 14 from the satellite 14. In an embodiment, the frame sync data comprise TOW (time of week) of the satellite 14. When the network delay is over a specific value, e.g. 20 ms, the second receiver 12 can use the frame sync data from the satellite 14 to calibrate the synchronization process. In another embodiment, the second receiver 12 performs a parity check on the code phase data. When the parity check of the first word of the code phase data fails, the second receiver 12 can use the frame sync data to calibrate the synchronization process, in which the first word of the code phase data described above means the first word of the code phase data tracked by the second receiver 12 after the second receiver 12 tracks the satellite 14. In contrast, when the parity check of the first word of the code phase data passes and the network delay is less than 300 ms, the second receiver 12 does not need the frame sync data to perform synchronization, and at least 1.2 to 6 seconds can be saved during the synchronization process.

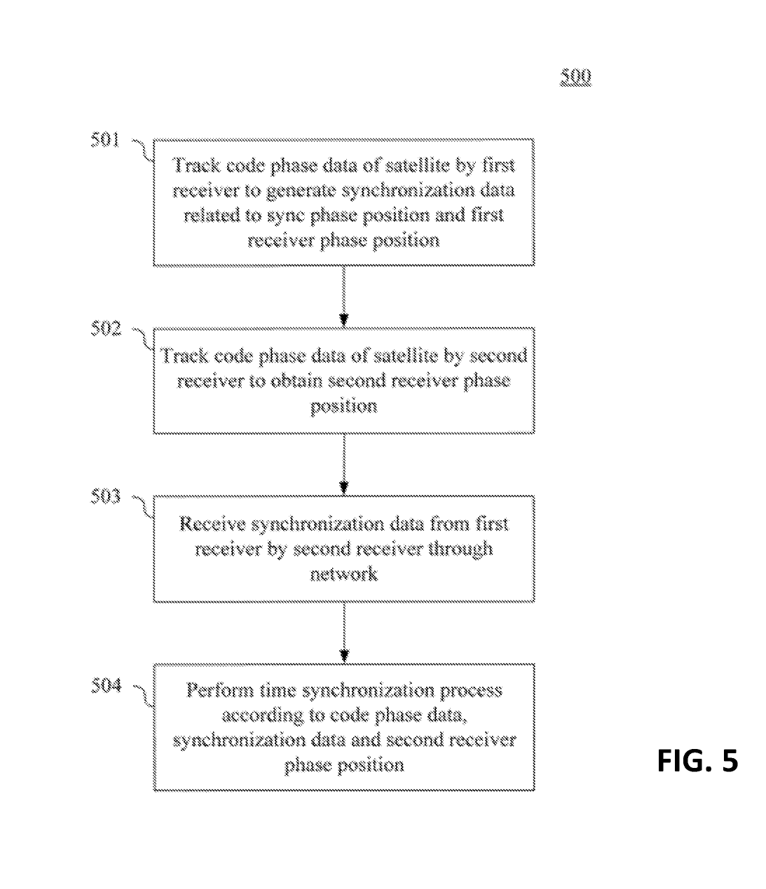

FIG. 5 is a flow chart of a time synchronization method 500 in an embodiment of the present invention. The time synchronization method 500 can be used in the wireless communication system 1 depicted in FIG. 1. The time synchronization method 500 comprises the steps outlined below (The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

In step 501, a code phase data 11 of a satellite 14 is tracked by a first receiver 10 to generate a synchronization data 13 related to a sync phase position and a first receiver phase position corresponding to one of a plurality of first receiver time pulses of a first receiver clock according to the code phase data 11.

In step 502, the code phase data 11 of the satellite 14 is tracked by a tracking unit 30 of a second receiver 12 to obtain a second receiver phase position corresponding to one of a plurality of second receiver time pulses of a second receiver clock.

In step 503, the synchronization data 13 is received from the first receiver 10 by a receiving unit 32 of the second receiver 12 through a network.

In step 504, a time synchronization process of the second receiver 12 with the first receiver 10 is performed by a computing unit 34 of the second receiver 12 according to the code phase data, the synchronization data and the second receiver phase position.

Aspects of the invention, such as the receiving unit, the tracking unit, and the computing unit, may be described in the general context of computer-executable instructions, such as program modules, being executed by a computer. Generally, program modules include routines, programs, objects, components, data structures, etc., that perform particular tasks or implement particular abstract data types. Moreover, those skilled in the art will appreciate that the invention may be practiced with a variety of computer-system configurations, including multiprocessor systems, microprocessor-based or programmable-consumer electronics, minicomputers, mainframe computers, and the like. Any number of computer-systems and computer networks are acceptable for use with the present invention.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A wireless communication system having a time synchronization mechanism, wherein the wireless communication system comprises:
a first processor with memory storing functions comprising functions for tracking a code phase data of a satellite to generate a synchronization data according to a sync phase position corresponding to one of a plurality of sync time pulses and a first processor phase position corresponding to one of a plurality of first processor time pulses of a first processor clock according to the code phase data; and
a second processor with memory storing functions comprising functions for:
receiving the synchronization data from the first processor through a network;
tracking the code phase data of the satellite to obtain a second processor phase position corresponding to one of a plurality of second processor time pulses of a second processor clock; and
performing a time synchronization process with the first processor according to the code phase data, the synchronization data and the second processor phase position.

2. The wireless communication system of claim 1, wherein the first processor generates the synchronization data by tracking the code phase data of the satellite after obtaining a position of the first processor relative to the satellite by a procedure of three-dimensional (3-D) fix and the computing unit performs the time synchronization process with the first processor and the satellite according to the code phase data, the synchronization data and the second processor phase position, in which the sync phase position is a satellite phase position corresponding to one of a plurality of satellite time pulses of a satellite clock.

3. The wireless communication system of claim 1, wherein the synchronization data comprises a first phase offset between the sync phase position and the first processor phase position, the computing unit further computes a second phase offset between the sync phase position and the second processor phase position according to the synchronization data.

4. The wireless communication system of claim 3, wherein the first and the second processors further generate a synchronized time pulse corresponding to the sync time pulse according to the first phase offset and the second phase offset.

5. The wireless communication system of claim 2, wherein the synchronization data further comprises a first processor clock drift and a first processor phase position difference between neighboring two of the first processor time pulses and the tracking unit obtains a second processor phase position difference between neighboring two of the second processor time pulses according to the tracking of the code phase data and the computing unit further computes a second processor clock drift according to the first processor phase position difference and the second processor phase position difference.

6. The wireless communication system of claim 1, wherein the receiving unit further receives rough position information relative to the first processor from the network to compensate a distance offset of the time synchronization process.

7. A time synchronization method, comprising:
tracking a code phase data of a satellite to generate a synchronization data by a first processor according to a sync phase position corresponding to one of a plurality of sync time pulses and a first processor phase position corresponding to one of a plurality of first processor time pulses of a first processor clock according to the code phase data;
tracking the code phase data of the satellite by a second processor to obtain a second processor phase position corresponding to one of a plurality of second processor time pulses of a second processor clock;
receiving the synchronization data from the first processor by the second processor through a network; and
performing a time synchronization process of the second processor with the first processor by the second processor according to the code phase data, the synchronization data and the second processor phase position.

8. The time synchronization method of claim 7, wherein the synchronization data is generated by tracking the code phase data of the satellite by the first processor after obtaining a position of the first processor relative to the satellite by a procedure of three-dimensional (3-D) fix and the time synchronization process is performed by the second processor with the first processor and the satellite according to the code phase data, the synchronization data and the second processor phase position, in which the sync phase position is a satellite phase position corresponding to one of a plurality of satellite time pulses of a satellite clock.

9. The time synchronization method of claim 7, wherein the synchronization data comprises a first phase offset between the sync phase position and the first processor phase position, the time synchronization process further comprises a step of calculating a second phase offset between the sync phase position and the second processor phase position by the second processor according to the synchronization data.

10. The time synchronization method of claim 9, wherein the time synchronization process further comprises a step of generating a synchronized time pulse corresponding to the sync time pulse according to the first phase offset and the second phase offset.

11. The time synchronization method of claim 7, wherein the synchronization data further comprises a first processor clock drift and a first processor phase position difference between neighboring two of the first processor time pulses and the second processor obtains a second processor phase position difference between neighboring two of the second processor time pulses according to the tracking of the code phase data, the time synchronization method further comprises a step of calculating a second processor clock drift by the second processor according to the first processor phase position difference and the second processor phase position difference.

12. The time synchronization method of claim 7, further comprising a step of receiving rough position information of the second processor relative to the first processor by the second processor from the network to compensate a distance offset of the time synchronization process.

13. A portable electronic processor with memory storing functions used in a wireless communication system having a time synchronization mechanism that comprises a receiver, the electronic processor comprises functions for:
receiving a synchronization data from the receiver according to a sync phase position corresponding to one of a plurality of sync time pulses and receiver phase position corresponding to one of a plurality of receiver time pulses of a receiver clock;
tracking a code phase data of a satellite to obtain an electronic device phase position corresponding to one of a plurality of electronic device time pulses of a device clock; and
computing a phase offset between the sync phase position and the electronic device phase position according to the code phase data, the synchronization data and the electronic device phase position to perform a time synchronization process.

14. The portable electronic processor with memory storing functions of claim 13, wherein the computing unit performs the time synchronization process with the receiver and the satellite according to the code phase data, the synchronization data and the electronic device phase position, in which the sync phase position is a satellite phase position corresponding to one of a plurality of satellite time pulses of a satellite clock.

15. The portable electronic processor with memory storing functions of claim 13, wherein the synchronization data further comprises a receiver clock drift and a receiver phase position difference between neighboring two of the receiver time pulses and the computing unit computes an electronic device phase position difference between neighboring two of the electronic device time pulses according to the tracking of the code phase data to further computes an electronic device clock drift according to the receiver phase position difference and the electronic device phase position difference.

16. The portable electronic processor with memory storing functions of claim 15, wherein the tracking unit further obtains a frame sync data of the satellite from the satellite such that the computing unit performs the time synchronization process according to the code phase data, the synchronization data, the electronic device phase position and the frame sync data when a parity check of first word of the code phase data fails.
